(19) United States
(12) Patent Application Publication
(10) Pub. No.: US 2002/0053255 A1
(43) Pub. Date: May 9, 2002

(54) CAMSHAFT FOR THE PERIODIC ACTUATION OF MOVABLY STORED ELEMENTS AND METHOD FOR THE PRODUCTION OF SUCH SHAFT

(75) Inventors: KONRAD KULUS, AURICH-WALLE (DE); ALFRED BEIER, BRAUNSCHWEIG (DE)

Correspondence Address: KLAUS P STOFFEL, COHEN PONTANI LIEBERMAN & PAVANE, 551 FIFTH AVENUE, SUITE 1210, NEW YORK, NY, 10176

(73) Assignee: COHEN, PONTANI, LIEBERMAN & PAVANE

(21) Appl. No.: 09/381,939

(22) PCT Filed: Mar. 19, 1998
(86) PCT No.: PCT/EP98/01624

(30) Foreign Application Priority Data
Mar. 25, 1997 (DE) 197 12 391.0

(51) Int. Cl. F16H 53/00

(52) U.S. Cl. 74/567

(57) ABSTRACT

The invention relates to a simplified, economical and rapid method for the production of a camshaft. In accordance with the invention, functional elements (2) consisting of a plurality of flat material layers (3) are deposited on a base shaft (1). The base shaft (1) is then deformed by hydraulic expansion in such a way that the functional elements (2) are fixed on the base shaft (1).

EP 0 230 731 B1 discloses a process and an apparatus in which a camshaft is formed by a hollow, tubular shaft which is inserted through openings of cams, the shaft subsequently being hydraulically expanded in order to bring the bounding wall of the shaft into contact with the openings of the cams and consequently to fix the latter on the shaft. In this case, for the rotational support of the camshaft, both cam elements and mountings are rested on the shaft. A multipart molding box which is formed by a multiplicity of axially successive, disc-like sections is used for the production of this camshaft. Formed in the correct positions in these sections are clearances for receiving the bearing sections or the cams.

This prior art offers the advantage that separately produced and monolithically formed cam or bearing elements can be produced and subsequently fixed by means of the hydraulic expansion on a comparatively lightweight shaft optimized for their function. However, the production of the cam or bearing elements requires comparatively great expenditure, since high requirements have to be set with respect to material selection, heat treatment and surface quality.

DE-44 23 107 A1 discloses how, as a departure from the known, monolithic design, a cam is prepared from a multiplicity of successive layers of flat material. This arrangement offers considerable advantages in terms of production costs and production times, since the layers of flat material can, for example, be punched out from a heat-treated steel and subsequently assembled together to form a cam ready for use. Further material treatment and surface machining is not required.

The invention is based on the object of specifying a camshaft for the periodic actuation of movably mounted elements and a process for its production, which are respectively improved in terms of production costs and production time.

This object is successfully achieved by the features of Patent claim 1 for a camshaft and by the features of Patent claim 6 for a process for its production.

Advantageous developments of the invention are specified in dependant claims.

According to the invention, it is provided that the camshaft is formed by a hollow-cylindrical basic shaft and functional elements fixed thereupon by means of hydraulic expansion, these functional elements, for example cam discs or bearing sections, being made up in each case of a plurality of layers of flat material. The invention offers the advantage that different types of functional elements of the camshaft can be formed by layers of flat material in a comparatively low-cost production process and these functional elements can subsequently be fixed on a basic shaft in a likewise low-cost process. Compared with known arrangements and processes, considerable potential for savings is consequently realized, without in any way neglecting functional features.

In one preferred embodiment of the invention, it is provided that the layers of flat material made up into assemblies are placed into corresponding clearances of a mold and then the basic shaft is inserted through the through-openings of the assemblies. The hydraulic expansion of the basic shaft subsequently takes place, whereby the assemblies are fixed on the basic shaft. The individual clearances of the molding box can in this case be arranged such that they are turned in their relative position with respect to one another, so that in the end a functionally appropriate positional assignment of the cams or bearing elements takes place.

In another preferred embodiment, it may be provided that the basic shaft is provided with a groove which opens out at least in one of its end faces and runs in the longitudinal direction on its outer surface, the functional elements are provided with a corresponding lug, protruding into the through-opening, so that the functional elements can subsequently be pushed onto the basic shaft with the lugs engaging in the groove. It is preferred here, in particular in the case of the cam elements, if the lugs can have positions deviating from one another relative to the maximum cam lobe, so that, in spite of a single groove which can be produced simply and at low cost, the respective cam element assumes its predetermined relative position. Since the position in the circumferential direction of each element is already predetermined here, the molding box preferably does not require clearances formed exactly to correspond.

In both embodiments it is provided with preference that, after the hydraulic expansion of the basic shaft, an external diameter of this basic shaft between neighboring functional elements is chosen to be greater than an external diameter of this basic shaft in the region of these functional elements. As a result, in addition to the fixing of the functional elements, the expansion ensures a securing of these elements in the axial direction by forming shoulders at the changes in diameter. The radial expansion in the region of these shoulders is limited by correspondingly formed stops in the molding box.

As a departure from this, it may also be arranged for the diameters to be of a converse assignment in such a way that, after the hydraulic expansion, the basic shaft has a smaller external diameter between the functional elements.

To avoid stress peaks in the transitional region of the change in diameter in the individual layers of flat material, it may be provided that the stops limiting the radial expansion comprise elements of a disc or angle form which, bearing against the functional elements on both sides, ensure that the change in diameter takes place at a specific axial distance from the respectively outer layers of flat material.

In a further preferred development, it may be provided that the through-opening of the functional elements bears a serration which, in interaction with the hydraulic expansion of the basic shaft, serves for an additional, positive-locking clamping of the functional elements.

Furthermore, in addition to this or alternatively, the through-opening may deviate from a circular shape and consequently likewise effect positive locking against twisting.

Furthermore, it may be provided with preference that, in addition to the already mentioned cam or bearing elements, further functional elements are arranged on the basic shaft, such as for example so-called head or end pieces, which for their part in turn may bear, for example, gear wheels or sprockets for driving this camshaft.

The camshaft according to the invention is used with preference in internal combustion engines of motor vehicles and actuates elements which are movably mounted in a cylinder head and are designed as gas-exchange valves.

In addition, however, a number of other uses are conceivable, for example in stationarily operated machines or automatic units for the mechanical control of periodically recurring events.

Further advantages and features of the invention emerge from the patent claims and from the following description of an exemplary embodiment with reference to a drawing, in which:

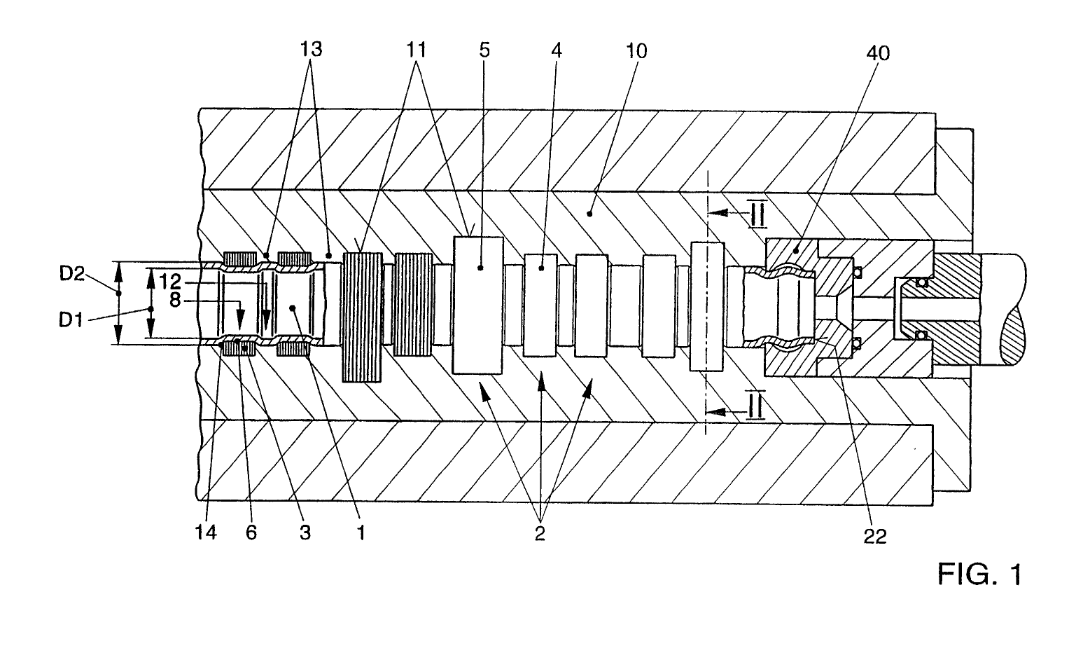

FIG. 1 shows a camshaft in a molding box after hydraulic expansion, partly broken away,

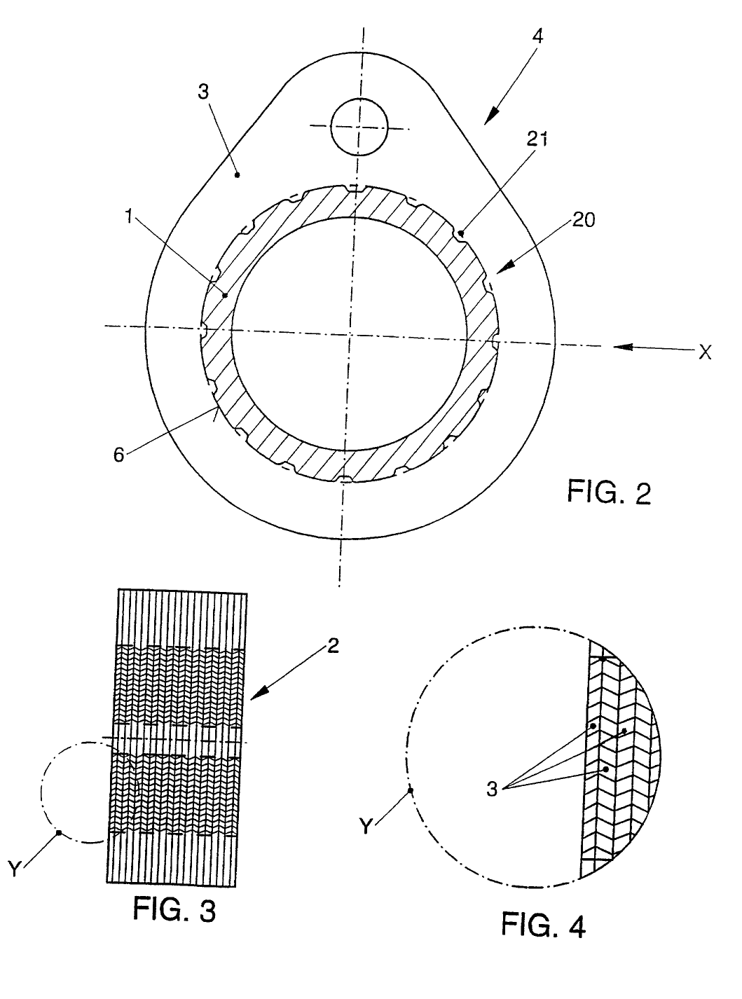

FIG. 2 shows a section through an embodiment of the invention along the line II-II according to FIG. 1,

FIG. 3 shows a view in the direction of arrow X according to FIG. 2,

FIG. 4 shows an enlarged detail Y according to FIG. 3,

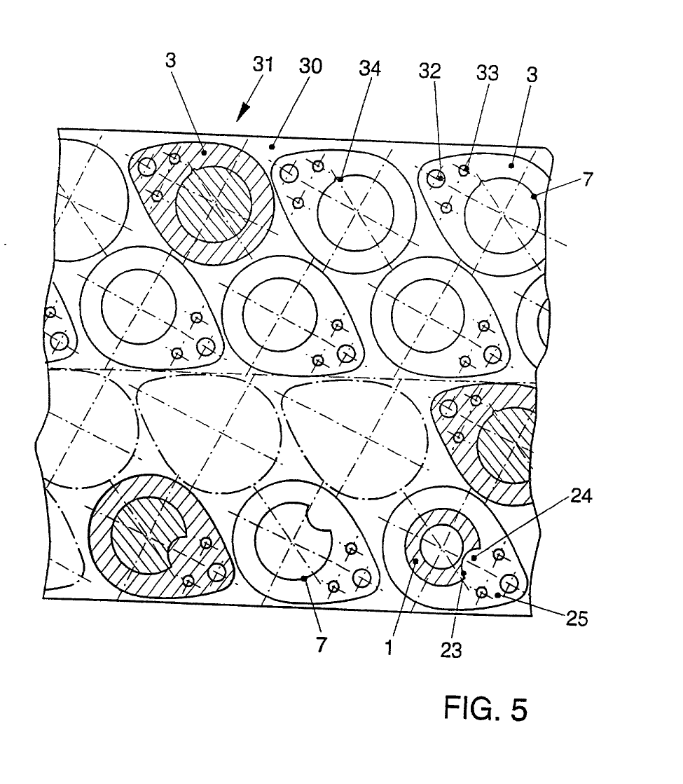

FIG. 5 shows a plurality of layers of flat material for a cam disc,

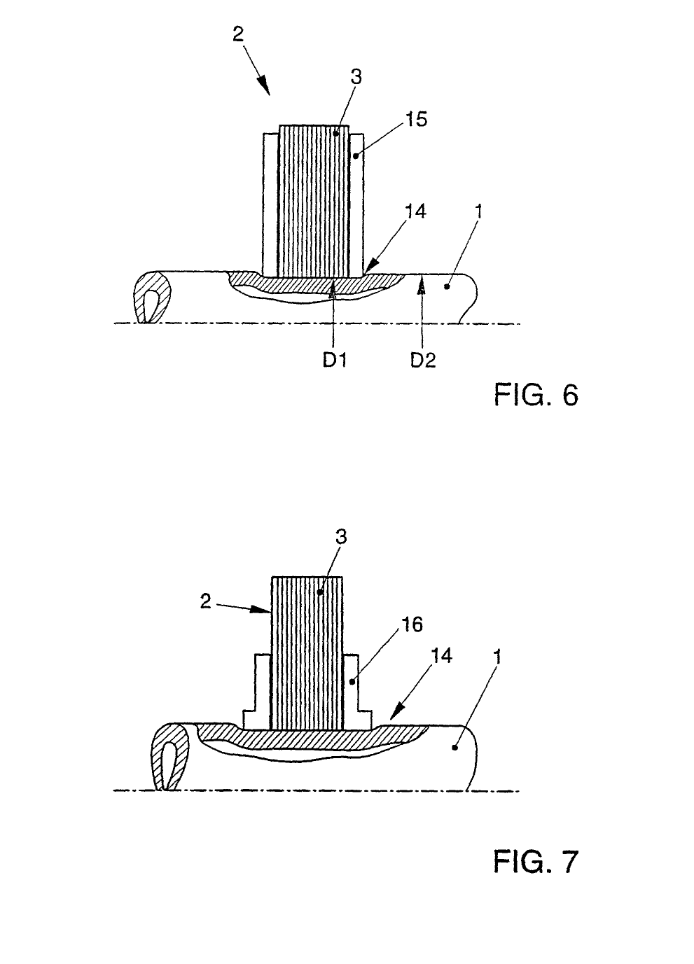

FIG. 6 shows a cam disc with a stop after hydraulic expansion and

FIG. 7 shows a cam disc with a further stop after hydraulic expansion.

A camshaft substantially comprises a basic shaft 1 and a plurality of functional elements 2 spaced axially apart from one another and arranged on the said basic shaft. These functional elements 2 are respectively formed by a plurality of layers of flat material 3, which when combined in an assembly form, for example, a functional element 2 designed as a cam disc 4 or a functional element 2 designed as a bearing ring 5.

Each functional element 2 has a through-opening 6, which is formed altogether by all the openings 7 of an assembly of layers of flat material 3.

The basic shaft 1 is threaded through these through-openings 6, the said basic shaft initially being of a hollow-cylindrical design with an external diameter which is dimensioned to be slightly less than the smallest diameter of the through-opening 6. After all the functional elements 2 are positioned in predetermined sections 8 of the basic shaft 1, which are axially spaced apart from one another, the said basic shaft is subjected to hydraulic pressure inside it within a mold 10.

In the case of this process known per se, the basic shaft is filled, for example, with a liquid medium and the latter is subsequently subjected to an adequate pressure. On account of the excess pressure, the basic shaft experiences a radial expansion, as a result of which the outer surface of the basic shaft 1 approaches the circumference of the through-opening 6 and finally comes to bear against the latter. As a result of this, the functional elements 2 are fixed on the basic shaft 1 and the complete camshaft is consequently formed.

In an embodiment according to FIG. 1, initially cam discs 4 or bearing rings 5 are formed by assembling a plurality of layers of flat material 3 and these assemblies are subsequently placed in the correct position into clearances 11 of the mold 10 which are individual to the functional elements. Subsequently, the hollow basic shaft 1, which is initially of a cylindrical design on its inner and outer circumference, is threaded through the through-openings 6 and is subsequently put under pressure in the way described above.

In the mold 10, radially effective stops 13 are arranged adjacent to sections 12 formed between the sections 8 bearing the functional elements 2. During the hydraulic expansion, the radial expansion of the basic shaft 1 is consequently limited in the region of the sections 8 by the circumference of the through-openings 6 and in the region of the sections 12 by the stops 13. The diameters of the basic shaft 1 which occur as a result are dimensioned such that an external diameter D1 in the region of the sections 8 is dimensioned to be less than an external diameter D2 in the region of the stops 13. Lying against shoulders 14 formed by the change in diameter between D1 and D2 are lateral end faces 15 of the functional elements 2, as an axial positional securement.

According to an embodiment as shown in FIGS. [sic] 6 or 7, the stops 13 may have disc elements 15 or angle elements 16. These ensure during the hydraulic expansion that the change in diameter between D1 and D2 in the region of the shoulder 14 occurs at an axial distance from the respectively outer layers of flat material 3. As a result, stress peaks in the region of these lamella layers are reliably avoided.

For increased securement against twisting of the functional elements 2 on the completed camshaft, each opening 7 may be provided with a serration 20, teeth 21 of the latter, facing radially into this opening 7, embedding themselves in the basic shaft 1 during the hydraulic expansion of the said shaft and ensuring that high torques can be transmitted.

In another embodiment of the invention, the clearances 11 of the mold 10 are superfluous, since the basic shaft 1 is provided on its outer surface with a groove 23, opening out in at least one end face 22 of the basic shaft 1, and each layer of flat material 3 is provided with a lug 24, facing radially into the opening 7 and corresponding to the groove 23. According to this embodiment, the functional elements 2 are pushed onto the basic shaft 1, with the lugs 24 engaging in the groove 23, and the said shaft is subsequently hydraulically expanded. With the aid of the relative position of the lug 24 in the through-opening 6, or in the openings 7, an exact circumferential positioning of the functional elements 2 on the camshaft is ensured.

As can be seen from FIG. 5, the relative positions of the lugs 24 with respect to the respective cam lobe 25 of a layer of flat material 3 deviate from one another. The interaction with the basic shaft 1 and its groove 23 is represented in this FIG. 5, with respect to the layer of flat material 3 shown at the bottom right, only for better understanding. FIG. 5 otherwise shows a strip of flat material 30 of cold-rolled steel sheet, for example Ck 70. From this strip, moving from left to right within a punching machine, there are punched out with the aid of a suitable punching tool, for example, in each case four layers of flat material 3, lying along an oblique row 31.

The serration 20 may be additionally provided in the case of this embodiment of the invention as well.

FIG. 5 shows by way of example, in the upper half, layers of flat material 3 as they can be used for the embodiment described first, without grooves 23 and lugs 24. Furthermore, clearances 32 and 33 of each layer of flat material 3 are represented. These serve, on the one hand, for weight reduction and can therefore also be provided in a greater number than shown, depending on loading. The clearances 32, dimensioned to be slightly larger, may similarly serve for receiving a pin (not shown) for improving the assembling capability of the layers of flat material 3.

The handling of the plurality of layers of flat material 3, combined into assemblies, may be improved by adhesively bonding, riveting, caulking or laser welding or the like the layers of flat material 3 to one another. Rivets may, in this case, pass for example through the clearances 32 and/or 33. Laser welding may take place, for example, in a groove 34 provided especially for this, and shown in FIG. 5 on some layers of flat material 3, extending radially outwards with respect to the opening 7.

If direct mounting of the basic shaft 1 in part of a machine is planned, the bearing ring 5 shown in FIG. 1 may be omitted and, for example, the outer surface of the basic shaft 1 lying in this section may serve as a bearing surface. With the aid of the hydraulic expansion described above and a corresponding clearance 11, the high precision required for this is ensured.

In addition to the functional elements 2 described, in the form of the cam discs 4 and the bearing ring 5, the camshaft may have a molded-on head piece, lying on the left in FIG. 1 and not shown, and an end piece 40, lying on the right. These head and end pieces 40 may be connected to the basic shaft 1 in a positive and non-positive manner by the hydraulic expansion and may serve, for example, for driving a flange-mounted unit, driven by the camshaft, or for receiving a belt or chain pulley, driving the camshaft.

As a departure from the substantially circular shape of the openings 7 shown, by simple modification of the punching tool the said openings may have, for example, an oval or approximately triangular shape, an additional positive-locking clamping of the functional elements 2 then taking place when an initially circular basic shaft 1 is used.

In addition to the advantages already mentioned in terms of production times and material costs, etc., this constructed camshaft has favorable acoustic characteristics on account of its internal friction between the interfaces of mutually facing layers of flat material 3.

1. Camshaft for the periodic actuation of movably mounted elements, having a hollow basic shaft (1) and functional elements (2) which are fixed thereupon by means of hydraulic expansion of this basic shaft (1) and have a through-opening (6) for receiving the basic shaft (1), characterized in that the functional elements (2) are made up of a plurality of layers of flat material (3).

2. Camshaft according to claim 1, characterized in that at least one functional element (2) comprises a bearing ring (5), provided with the through-opening (6), for the mounting of the camshaft.

3. Camshaft according to one of claims 1 or 2, characterized in that the basic shaft (1) has in the region of the through-opening (6) an external diameter (D1) which is dimensioned to be less than an external diameter (D2) of the basic shaft (1) immediately adjacent to a side end face (15) of the functional elements (2).

4. Camshaft according to one of claims 1 to 3, characterized in that the basic shaft (1) bears on its outer surface a groove (23) which runs in the longitudinal direction and in which there engage correspondingly formed lugs (24) of the functional elements (2), protruding into the through-opening (6).

5. Camshaft according to claim 4, characterized in that on the basic shaft (1) there are arranged functional elements (2) designed as cam discs (4) and of which the positions of the lugs (24) relative to a cam lobe (25) deviate from one another.

6. Process for producing a camshaft according to claim 1, with the steps of
a) fitting a plurality of assemblies, formed by layers of flat material (3), onto predetermined sections (8) of the basic shaft (1) which are axially spaced apart from one another,
b) hydraulically expanding the basic shaft (1), at least in the sections (8) bearing the assemblies, for fixing securely against twisting on the basic shaft (1).

7. Process according to claim 6, characterized in that, before step a), the basic shaft (1) is provided with a groove (23) running in the longitudinal direction and opening out at least in one end face (22) of the basic shaft (1), and the layers of flat material (3), provided with corresponding lugs (24), are applied in step a), with the lugs (24) engaging in this groove (23).

8. Process according to claim 6, characterized in that, initially in a step a1), the layers of flat material (3), combined in assemblies, are placed into clearances (11) of a mold (10) individual to the functional elements and then, in a step a2), the basic shaft (1) is inserted through the through-openings (6), so that the assemblies are positioned relative to the predetermined sections (8) of the basic shaft (1).

9. Process according to claim 7 or 8, characterized in that the hydraulic expansion takes place in a mold (10) which receives the camshaft and, by means of stops (13), limits the radial expansion of the basic shaft (1) in the sections (12) lying between the sections (8) bearing the assemblies in such a way that the external diameter (D2) occurring in these sections (12) after the hydraulic expansion is dimensioned to be greater than the external diameter (D1) of the sections (8) bearing the assemblies.

10. Process according to claim 9, characterized in that the stops (13) are designed in such a way that the shoulder (14) occurring due to the transition from the external diameter (D1) to the external diameter (D2) is formed such that it is axially at a distance from the respectively outer layers of flat material (3).
